(19) United States
(12) Patent Application Publication
(10) Pub. No.: US 2013/0271371 A1
(43) Pub. Date: Oct. 17, 2013

(54) ACCURATE EXTENDED POINTING APPARATUS AND METHOD THEREOF

(71) Applicants: Chia-Chun TSOU, New Taipei City (TW); Tsang-Chi LI, New Taipei City (TW)

(72) Inventors: Chia-Chun TSOU, New Taipei City (TW); Tsang-Chi LI, New Taipei City (TW)

(73) Assignee: UTECHZONE CO., LTD., New Taipei City (TW)

(21) Appl. No.: 13/447,056

(22) Filed: Apr. 13, 2012

(51) Int. Cl. G06F 3/033

(52) U.S. Cl. 345/158

(57) ABSTRACT

An accurate extended pointing device and a method thereof is disclosed, which use a line vector formed by a user's finger and hand to move an indicator on a screen. The accurate extended pointing device mainly includes: an image capturing unit, being configured to capture a user image; and a directional processing unit, being configured to analyze the user image to generate a piece of user finger image data and a piece of user hand image data and generate a virtual pointing vector according to the user finger image data and the user hand image data. According to the virtual pointing vector, the operation indicator in the working frame is controlled to move as the line vector formed by the user's finger and hand moves, and the operation indicator is located at a location where the virtual pointing vector intersects with the working frame.

### BACKGROUND OF THE INVENTION

1. Technical Field

The present invention relates to a pointing apparatus and a method thereof, and more particularly, to an accurate extended pointing apparatus and method thereof suitable for use with a large screen.

2. Description of Related Art

A number of technologies that detect a body movement of a human being for purpose of various control operations have been disclosed. For example, U.S. Pat. No. 7,931,535 entitled “Game operating device” has disclosed a game controller, i.e., a Wii remote controller for Wii game machines developed by Nintendo Co., Ltd of Japan. The game controller is provided with a video camera, an accelerator sensor and control buttons therein, and an infrared (IR) light emitter is disposed atop a television (TV) set. By using the video camera to capture an IR light emitted by the IR light emitter, a location of the game controller relative to a screen of the TV set can be determined so that a game can be manipulated.

U.S. Patent Publication No. US2010/0302145 entitled “Virtual desktop coordinate transformation” has disclosed another technology. According to this technology, a video camera is installed on a TV set to acquire an image of a player who stands in front of the TV set, and through computational processing by a host of a game machine, a body movement of the player can be observed to accomplish various control operations in the game. This technology is mainly characterized in that, after being analyzed, the image of the player is directly mapped into a frame displayed by the TV set. As shown in FIG. 1, when the player waves one of his arms, an indicator in the frame moves almost synchronously, and the indicator appearing in the screen of the TV set is located just at a position corresponding to the player's palm as if the player were standing in front of a mirror.

Although the technologies described above can operate reasonably to deliver an effect to some extent, the technology disclosed in U.S. Pat. No. 7,931,535 requires that the user hold a particular game controller in order to manipulate the game. Furthermore, the technology disclosed in U.S. Patent Publication No. US2010/0302145 is only suitable for screens of common sizes (e.g., household liquid crystal display (LCD) TV sets). Neither of the technologies is suitable for use with apparatuses having large screens (e.g., outdoor advertisement billboards) or performs control operations in such apparatuses. The reason is that, it is totally impossible for the user to interact with the large screens because the user looks so small in front of the large screens.

### SUMMARY OF THE INVENTION

In view of this, the present invention provides an accurate extended pointing apparatus and method thereof, which use a virtual pointing vector formed by images of a user's finger and hand to control an indicator in a frame. The present invention features intuitive and simple operations, so it enjoys great advantages in commercial applications such as exhibitions or advertisements.

The accurate extended pointing apparatus according to the present invention works in combination with a display apparatus to allow for control operations by a user, and the display apparatus is adapted to generate a working frame. The accurate extended pointing apparatus of the present invention mainly comprises an image capturing unit and a directional processing unit. The image capturing unit is configured to capture a user image. The directional processing unit, which is connected with an image processing unit, is configured to analyze the user image to generate a piece of user finger image data and a piece of user hand image data and generate a virtual pointing vector according to the user finger image data and the user hand image data. The operation indicator in the working frame is controlled according to the virtual pointing vector so that the operation indicator moves in the working frame as the user's finger and hand move and the user's finger and hand are roughly located on a same line as the operation indicator (i.e., the operation indicator is located at a location where the virtual pointing vector intersects with the working frame).

The technology disclosed in U.S. Patent Publication No. US2010/0302145 operates like a mirror to capture and analyze an image of a player and then map the image of the player onto a screen. That is, the technology disclosed in U.S. Patent Publication No. US2010/0302145 operates to directly reflect a body movement of the player onto the screen correspondingly. As compared to this, the technology disclosed in the present invention obtains a line formed by images of the user's finger and hand and, through computational processing, obtains a virtual pointing vector, so the user can point to any region in the screen freely. The technology disclosed in the present invention is particularly suitable for use with a large-sized screen, provides an innovative operation mode for various advertisements and promotions using outdoor large screens, and features intuitive and simple operations.

The detailed features and advantages of the present invention will be described in detail with reference to the preferred embodiment so as to enable persons skilled in the art to gain insight into the technical disclosure of the present invention, implement the present invention accordingly, and readily understand the objectives and advantages of the present invention by perusal of the contents disclosed in the specification, the claims, and the accompanying drawings.

### BRIEF DESCRIPTION OF THE SEVERAL VIEWS OF THE DRAWINGS

FIG. 1 is a schematic view illustrating operations of the prior art;

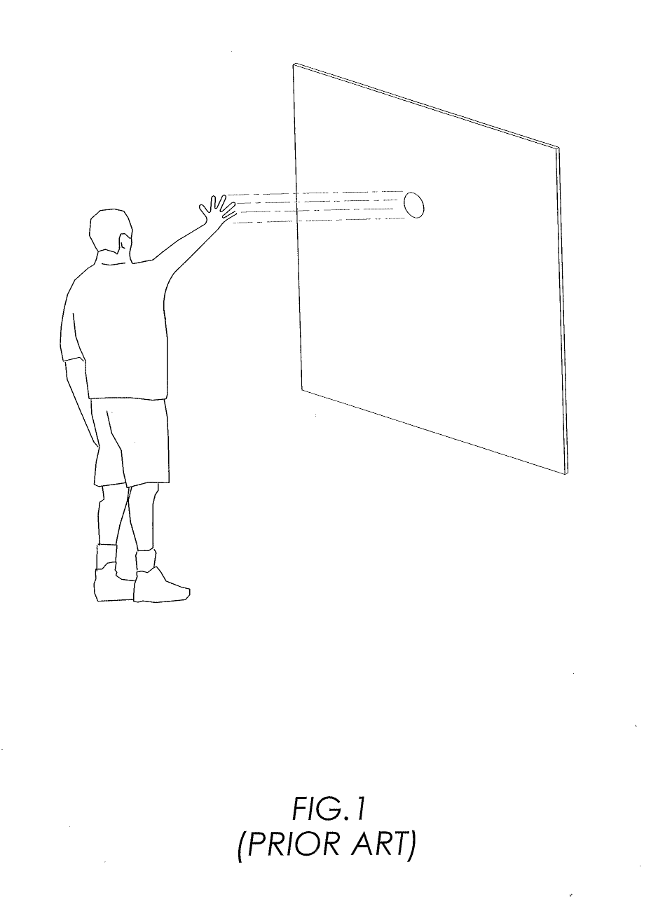

FIG. 2 is a schematic view illustrating operations of a device of one embodiment of the present invention;

FIG. 3 is another schematic view illustrating the operations of the device of the embodiment of the present invention;

FIG. 4 is a schematic view illustrating an architecture of the device of the embodiment of the present invention;

FIG. 5 is a schematic flowchart diagram of a method of one embodiment of the present invention; and

FIG. 6 is a continued schematic flowchart diagram of the method of the embodiment of the present invention.

### DETAILED DESCRIPTION OF THE EMBODIMENTS OF THE INVENTION

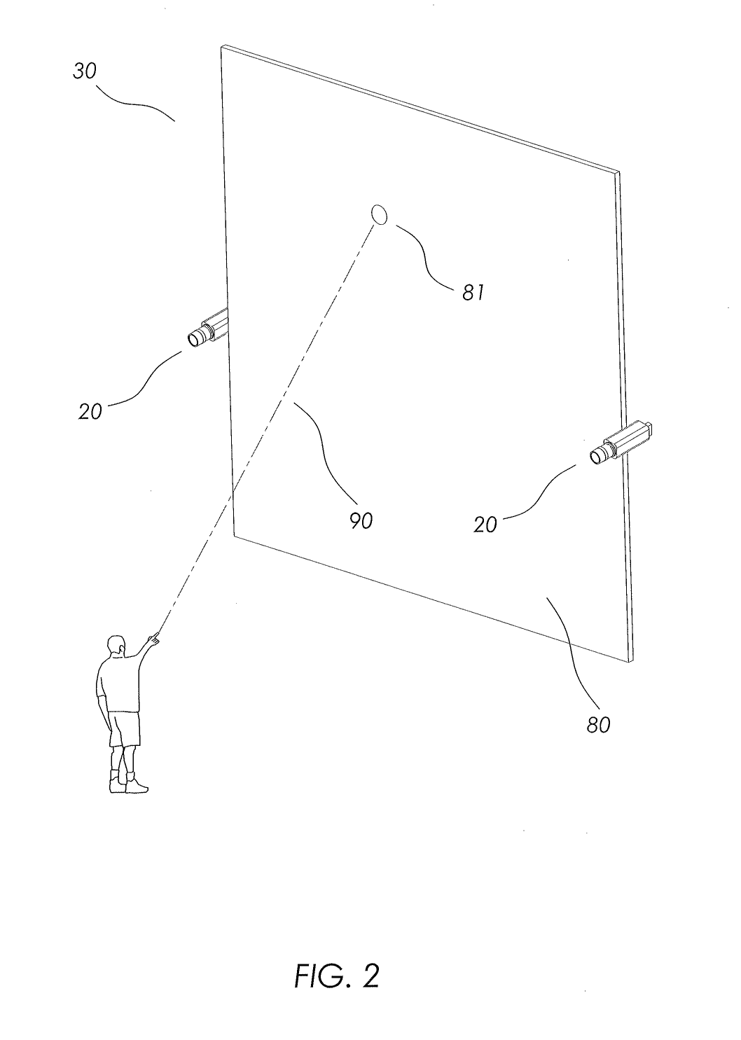

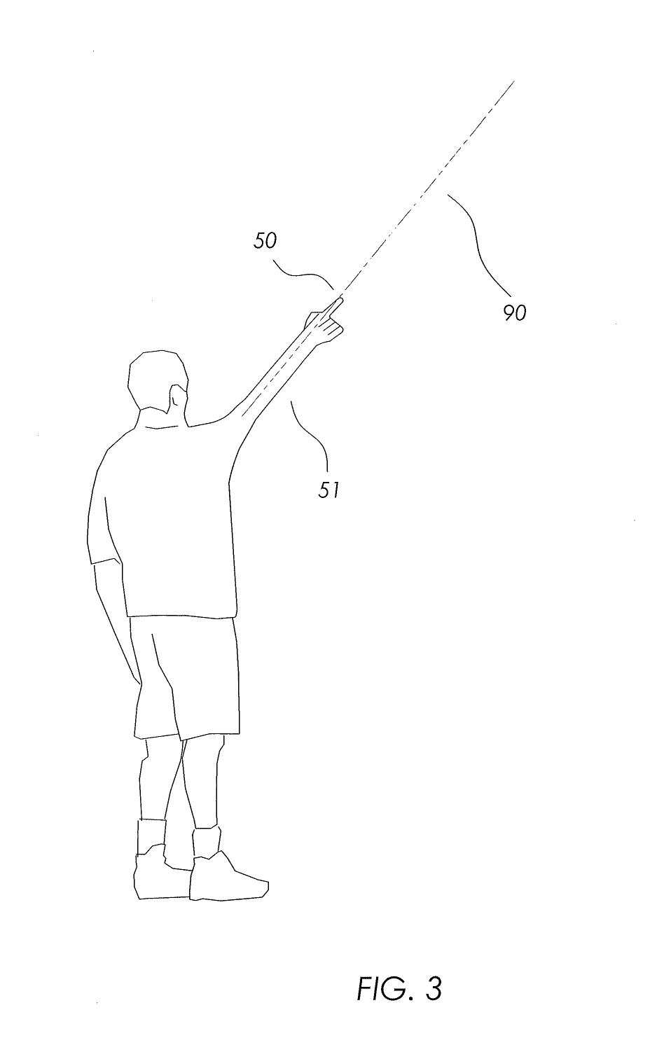

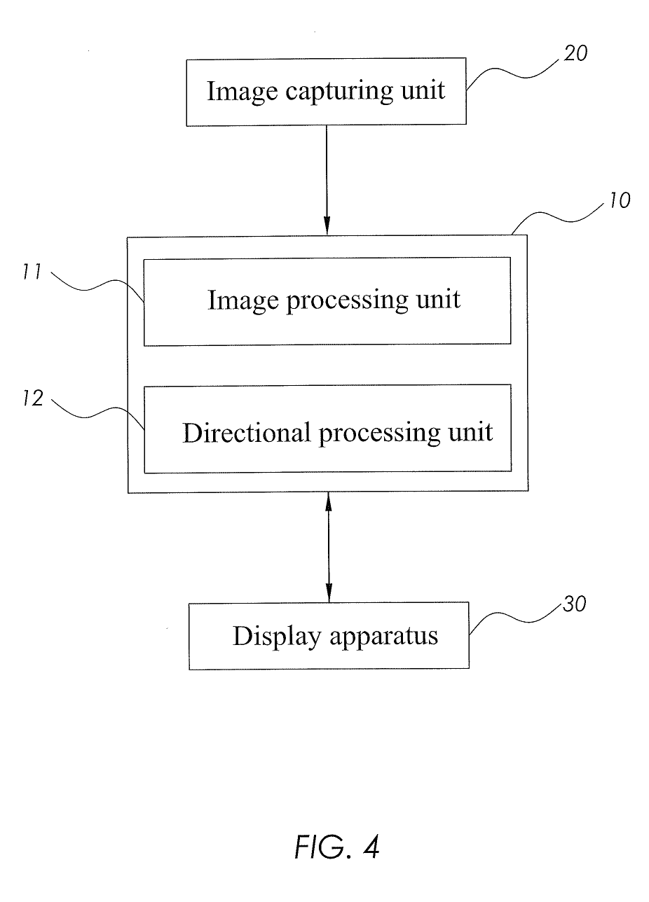

Referring to FIG. 2, FIG. 3 and FIG. 4, a basic architecture and operations of an accurate extended pointing apparatus of one embodiment of the present invention are illustrated therein. The accurate extended pointing apparatus of the embodiment of the present invention works in combination with a display apparatus 30 such as an outdoor large display screen. The accurate extended pointing apparatus of the embodiment of the present invention mainly comprises a processing unit 10, an image processing unit 11, a directional processing unit 12, and an image capturing unit 20. The image capturing unit 20 comprises a first shooting module and a second shooting module. The first shooting module captures a user image and the second shooting module captures a user image from another angle, and three dimensional (3D) space coordinates of the user in the space can be obtained through calculations. It shall be supplemented that, the second shooting module may also be a depth shooting module for capturing a piece of positional depth data of the user relative to the image capturing unit 20. Alternatively, the image capturing unit 20 may directly use a depth shooting module instead of an image module to capture a piece of user space data. The 3D space coordinates of the user in the space may also be obtained according to the user space data obtained by the depth shooting module.

The image processing unit 11 in the processing unit 10, which is connected to the image capturing unit 20, can preliminarily process the user image, e.g., adjust the brilliance or brightness of the image or sharpen the image. The directional processing unit 12, which is connected with the image processing unit 11, receives and analyzes the user image processed by the image processing unit 11 to generate a piece of user finger image data and a piece of user hand image data and then generate a virtual pointing vector 90 according to the user finger image data and the user hand image data. The user hand image data is an image of a hand wrist, an image of an elbow, or an image of an arm. Furthermore, the directional processing unit 12 can further construct a piece of virtual 3D space data according to the user image and the virtual pointing vector 90. When the depth shooting module is used, the user space data such as 3D spatial position information of the user's head, body, hand, and foot in the space can be obtained.

The directional processing unit 12 can further analyze and process a working frame 80 (having coordinate data of the X axis and the Y axis) provided by the display apparatus 30, and control an operation indicator 81 in the working frame 80 according to the virtual pointing vector 90 (having coordinate data of the X axis, the Y axis, and the Z axis) and the virtual 3D space data (having coordinate data of the X axis, the Y axis, and the Z axis). The operation indicator 81 moves in the working frame 80 as the virtual pointing vector 90 formed by images of the user's finger 50 and hand 51 moves. When the user's hand moves, the user's finger 50 and hand 51 are roughly located on a same line as the controllable object 81 (i.e., the operation indicator 81 is roughly located on an extension line of the virtual pointing vector 90 and at a location where the virtual pointing vector 90 intersects with the working frame 80). Thus, regardless of the size of the screen, the user can freely move the operation indicator 81 to any location in the screen. As shown in FIG. 2, the accurate extended pointing apparatus disclosed in the embodiment of the present invention is particularly suitable for use with an apparatus having a large screen.

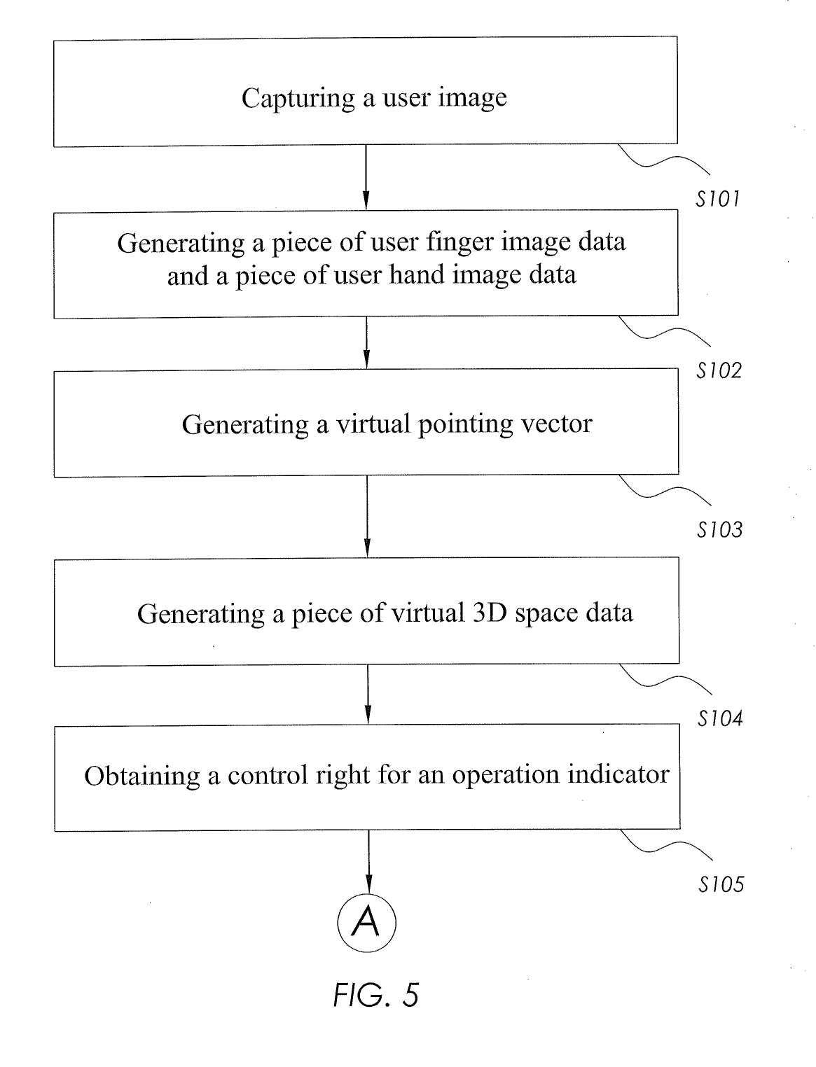

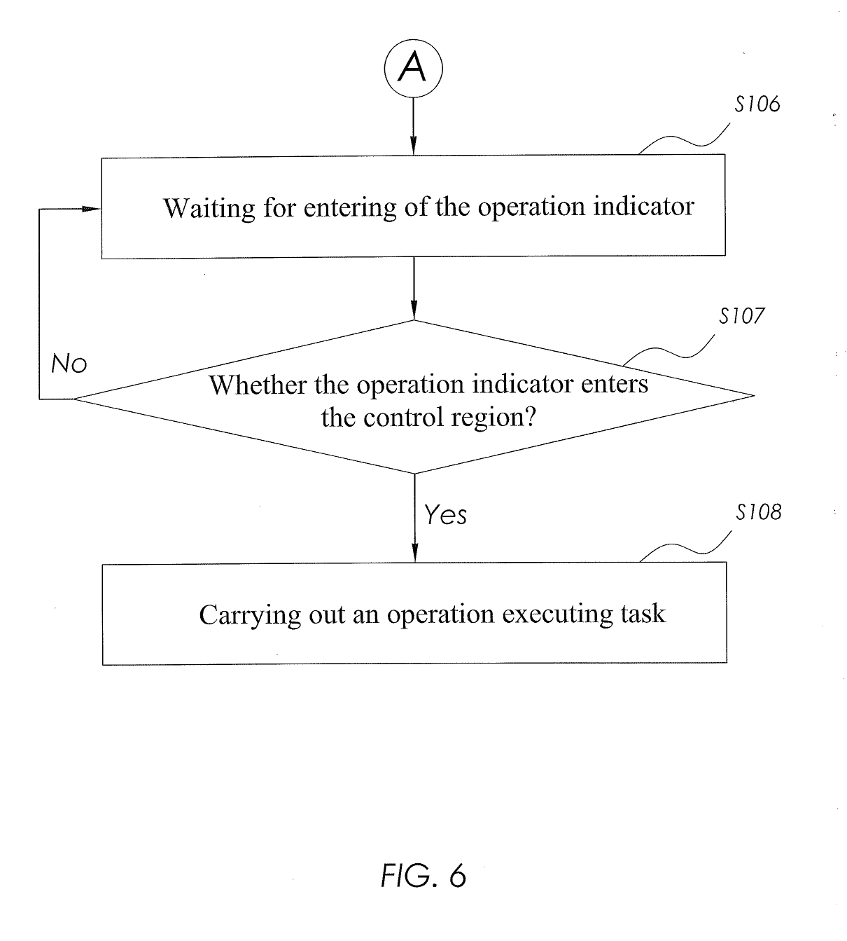

The embodiment of the present invention further provides an accurate extended pointing method. The procedure of the method of the embodiment of the present invention will be described in conjunction with the description of the aforesaid device and with reference to FIG. 5 and FIG. 6. The method provided by the embodiment of the present invention can work in combination with a display apparatus. Firstly, capture a user image (S101). Then, analyze the user image to generate a piece of user finger image data and a piece of user hand image data (S102). Generate a virtual pointing vector according to the user finger image data and the user hand image data (S103). Then, generate a piece of virtual 3D space data according to the user image and the virtual pointing vector (S104). Then, obtain a control right for an operation indicator in a working frame of the display apparatus (S105), with the operation indicator moving in the working frame as the user's finger and hand move and the user's finger and hand being roughly located on a same line as the operation indicator. That is, the operation indicator is located on an extension line of the virtual pointing vector and at a location where the virtual pointing vector intersects with the working frame. Next, at the end of the display apparatus, wait for the operation indicator entering a control region in the working frame (S106), and detect whether the operation indicator enters the control region (S107). If the operation indicator does not enter the control region, then step S106 is executed again; otherwise, if the operation indicator enters the control region, then an operation executing task is carried out according to the movement of the operation indicator (S108). The operation executing task may be, for example, an operation confirmation instruction or an operation cancel instruction depending on different application scenarios. It shall be supplemented that, the aforesaid steps S106 to S108 are accomplished at the end of the display apparatus, and the display apparatus comprises a computer generating the working frame. Of course, the display apparatus may also be directly integrated in the device of the present invention. If a depth shooting module is used in the aforesaid procedure, then the depth shooting module will capture user space data such as 3D spatial position information of the user's head, body, hand, and foot in the space. The user image used in the aforesaid procedure is replaced with the user space data, the user finger image data is replaced with the user finger space data, the user hand image data is replaced with the user hand space data, and so on.

The features of the present invention are disclosed above by the preferred embodiment to allow persons skilled in the art to gain insight into the contents of the present invention and implement the present invention accordingly. The preferred embodiment of the present invention should not be interpreted as restrictive of the scope of the present invention. Hence, all equivalent modifications or amendments made to the aforesaid embodiment should fall within the scope of the appended claims.

What is claimed is:

1. An accurate extended pointing device, which works in combination with a display apparatus to allow for control operations by a user, the display apparatus being adapted to generate a working frame having an operation indicator that is controllable, the accurate extended pointing device comprising:
an image capturing unit, being configured to capture a user image; and
a directional processing unit, being configured to analyze the user image to generate a piece of user finger image data and a piece of user hand image data, generate a virtual pointing vector according to the user finger image data and the user hand image data, and control the operation indicator according to the virtual pointing vector, wherein the operation indicator moves in the working frame as the user's finger and hand move, and is roughly located at a location where the virtual pointing vector intersects with the working frame.

2. The accurate extended pointing device of claim 1, wherein the directional processing unit is configured to generate a piece of virtual three-dimensional (3D) space data according to the user image and the virtual pointing vector.

3. The accurate extended pointing device of claim 1, wherein the user hand image data is selected from a group consisting of an image of a hand wrist, an image of an elbow, and an image of an arm.

4. The accurate extended pointing device of claim 1, wherein the image capturing unit comprises one or more video cameras.

5. An accurate extended pointing method, which works in combination with a display apparatus to allow for control operations by a user, the display apparatus being adapted to generate a working frame having an operation indicator that is controllable, the accurate extended pointing method comprising the following steps of:
capturing a user image;
analyzing the user image to generate a piece of user finger image data and a piece of user hand image data;
generating a virtual pointing vector according to the user finger image data and the user hand image data; and
controlling the operation indicator according to the virtual pointing vector so that the operation indicator moves in the working frame as the user's finger and hand move and the operation indicator is roughly located at a location where the virtual pointing vector intersects with the working frame.

6. The accurate extended pointing method of claim 5, further comprising the following step of: generating a piece of virtual 3D space data according to the user'image and the virtual pointing vector.

7. The accurate extended pointing method of claim 5, wherein the user hand image data is selected from a group consisting of an image of a hand wrist, an image of an elbow, and an image of an arm.

8. The accurate extended pointing method of claim 5, wherein the user image is captured by one or more video cameras.

9. The accurate extended pointing method of claim 5, further comprising the following steps of:
detecting whether the operation indicator enters a control region in the working frame; and
if the operation indicator enters the control region, then carrying out an operation executing task.

10. The accurate extended pointing method of claim 9, wherein the operation executing task refers to one of an operation confirmation instruction and an operation cancel instruction.

11. An accurate extended pointing device, which works in combination with a display apparatus to allow for control operations by a user, the display apparatus being adapted to generate a working frame having an operation indicator that is controllable, the accurate extended pointing device comprising:
an image capturing unit, being configured to acquire a piece of user space data; and
a directional processing unit, being configured to analyze the user space data to generate a piece of user finger space data and a piece of user hand space data, generate a virtual pointing vector according to the user finger space data and the user hand space data, and control the operation indicator according to the virtual pointing vector, wherein the operation indicator moves in the working frame as the user's finger and hand move, and is roughly located at a location where the virtual pointing vector intersects with the working frame.

12. The accurate extended pointing device of claim 11, wherein the user's hand corresponding to the user hand space data is selected from a group consisting of a hand wrist, an elbow, and an arm of the user.

13. An accurate extended pointing method, which works in combination with a display apparatus to allow for control operations by a user, the display apparatus being adapted to generate a working frame having an operation indicator that is controllable, the accurate extended pointing method comprising the following steps of:
acquiring a piece of user space data;
analyzing the user space data to generate a piece of user finger space data and a piece of user hand space data;
generating a virtual pointing vector according to the user finger space data and the user hand space data; and
controlling the operation indicator according to the virtual pointing vector so that the operation indicator moves in the working frame as the user's finger and hand move and the operation indicator is roughly located at a location where the virtual pointing vector intersects with the working frame.

14. The accurate extended pointing method of claim 13, wherein the user's hand corresponding to the user hand space data is selected from a group consisting of a hand wrist, an elbow, and an arm of the user.
